(19) United States
(12) Patent Application Publication
(10) Pub. No.: US 2006/0060021 A1
(43) Pub. Date: Mar. 23, 2006

(54) Control arm with two parallel branches

(76) Inventors: Alain Riwan, L'Hay les Roses (FR); Florian Gosselin, Vanves (FR)

Correspondence Address: PEARNE & GORDON LLP, 1801 EAST 9TH STREET, SUITE 1200, CLEVELAND, OH, 44114-3108, US

(21) Appl. No.: 11/239,775

(22) Filed: Sep. 30, 2005

Related U.S. Application Data
(63) Continuation-in-part of application No. 10/296,893, filed on Nov. 27, 2002, now abandoned.

(30) Foreign Application Priority Data
Jun. 21, 2000 (FR) 00 07930

(51) Int. Cl. B25J 17/02

(52) U.S. Cl. 74/490.04

(57) ABSTRACT

The master arm includes two parallel branches (1, 2), preferably symmetric, joining together at a control wrist (7). The branches are formed of segments (3, 4, 5, 6), the first (3) of which extend from a common base (8), and moving away from the base such that the branches move apart from each other and prevent the appearance of kinetic singularities.

### RELATED U.S. PATENT APPLICATIONS

Benefit of priority is claimed from U.S. patent application Ser. No. 10/296,893 filed on Nov. 27, 2002, which is the U.S. National stage of PCT/FR01/01927, filed on Jun. 20, 2001, the complete disclosures of which are hereby expressly incorporated herein by this reference thereto.

### FIELD OF THE INVENTION

The purpose of this invention is a control arm comprising two branches in parallel.

### BACKGROUND OF THE INVENTION

The function of control arms is to transfer movements applied to them by an operator as control instructions for an instrument or a system, usually a remote robot called a slave arm or a computer simulation. When the control arm has a sufficient number of degrees of freedom, the operator can control it in translation and in rotation in space.

The arms used in robotics have a very wide variety of shapes. The most traditional arms are composed of a sequence of segments connected to each other by articulations or sometimes by other types of joints; this arrangement is said to be “in series.” But there are disadvantages with these arms as soon as the number of segments becomes large. Thus, mechanisms located at joints have clearances which accumulate by producing a significant imprecision on the position of the free end of the arm. Furthermore, the motors that normally have to be added to the arm to control the conditions of the joints in order to modify their configuration, or on the other hand to keep them fixed regardless of the external forces applied to them, and that are often the heaviest part of the arms, create excessive bending moments that may make it necessary to reinforce the segments structure and therefore to further increase the weight of the arm, making it inconvenient to handle. It has been suggested that the motors should be transferred to the fixed base on which the arm is installed, but this solution requires transmissions between the motors and the joints that they control, which is not always possible and makes the arm complex.

This is why constructions using several (two or more) branches in parallel have been considered more recently in the history of robotics, and in which the distal ends are connected together. For the same number of degrees of freedom, the branches of the arms made in this manner are not as complex as in robots in series, which considerably attenuates the disadvantages of the lack of precision in the position of the arm and the weight of the branches. However, there are specific limitations with this type of robot. It may be difficult to make a simple control to bring them into a required state, due to their greater kinetic complexity; their working range is usually smaller than that of arms in series, since it is limited by the working range of the different branches in parallel and by collisions between segments of the different branches; finally, a defect correlated to the previous defect is that the number of singularities, which are configurations that must be avoided since the robot may be affected by uncontrolled movements, is usually greater.

Singularities correspond to local disappearances of degrees of freedom, or uncontrolled movements. Uncontrolled movement singularities are specific to parallel robots, but all singularities restrict the usage range of the arm. This disadvantage is more pronounced with master arms, which are not designed to apply repetitive movements or movements known in advance and that are controlled by hand, without thinking about singularities, and that may therefore be reached by improvisation. This is why they have to be limited, by transferring them to the ends of the working range.

The most similar document according to prior art is perhaps an article by Iwata entitled “Pen-based haptic virtual environment” (IEEE-ICRA, 1993, p. 287 to 292) that describes a parallel robot with two branches connected together by a wrist, but in which the branches are arranged side by side. This arm comprises singularities due to a degree of freedom of screwing in the wrist and risks of collision between the branches.

### SUMMARY OF THE INVENTION

It can be concluded from these various comments that arms in parallel are attractive as master arms due to the convenience in handling them, but their specific defects actually make many of them unsuitable for this application. The invention relates to a particular arrangement of arms in parallel, in which the main advantages are a large reduction in the number of collisions between the different bodies of the robot and singularities. The result is ease of control, so that the movement required to reach the required state can be imposed on them without difficulty.

These objectives are achieved with an arm with branches in parallel and with a special configuration; in its most general form, the invention relates to a robot arm composed of articulated segments distributed into two branches connected by a wrist, and the branches are made so as to extend from a common base in two halves on opposite sides of a separation plane when the said plane intersects the wrist, and they comprise corresponding segments connected to the base that extend in opposite directions from the base. Advantageously, the number of segments is the same in each branch; they can still be similar and symmetric if the segments switched to the base are co-linear with each other. In all cases, the branches are well separated from each other for almost all movements applied to the wrist, which almost completely eliminates collisions between the branches.

In accordance with one aspect, the present invention provides a robot arm that has two branches. Each of the branches includes symmetrically articulated segments. One end of each of the branches is connected by a wrist. The wrist is free to move in at least three translations and in at least two rotations. Another end of each of the branches is connected to a fixed common base through an articulation. The branches are made so as to move in two halves of space on opposite sides of a separation plane when the wrist is intersected by the plane. First segments of the branches which are connected to the base extend from the base and away from each other along directions that form an angle of between 90degrees and 180 degrees.

In accordance with another aspect, the present invention provides a robot arm that has two branches. Each of the branches includes symmetrically articulated segments. One end of each of the branches being connected by a wrist. The wrist is free to move in at least three translations and in at least two rotations. Another end of each of the branches is connected to a fixed common base through an articulation. The branches are made so as to extend, starting from the common base, in two halves of space on opposite sides of a separation plane, when the wrist is intersected by the plane. First segments of the branches are connected to the base through rotating articulations that extend from said base and away from each other along directions that form an angle of between 90 degrees and 180 degrees.

In one example of the invention, the branches comprise three first segments connected to each other and to the base by articulations with a force feedback motor, and a wrist connector segment.

In some variant embodiments, the arm may be fitted with a wrist holder with a constant orientation.

### BRIEF DESCRIPTION OF THE FIGURES

The invention will be described in more detail with reference to the following figures:

FIG. 1 is a diagrammatic view of the invention;

FIG. 2 is a view of an improved embodiment; and

FIG. 3 is a view of an improved wrist.

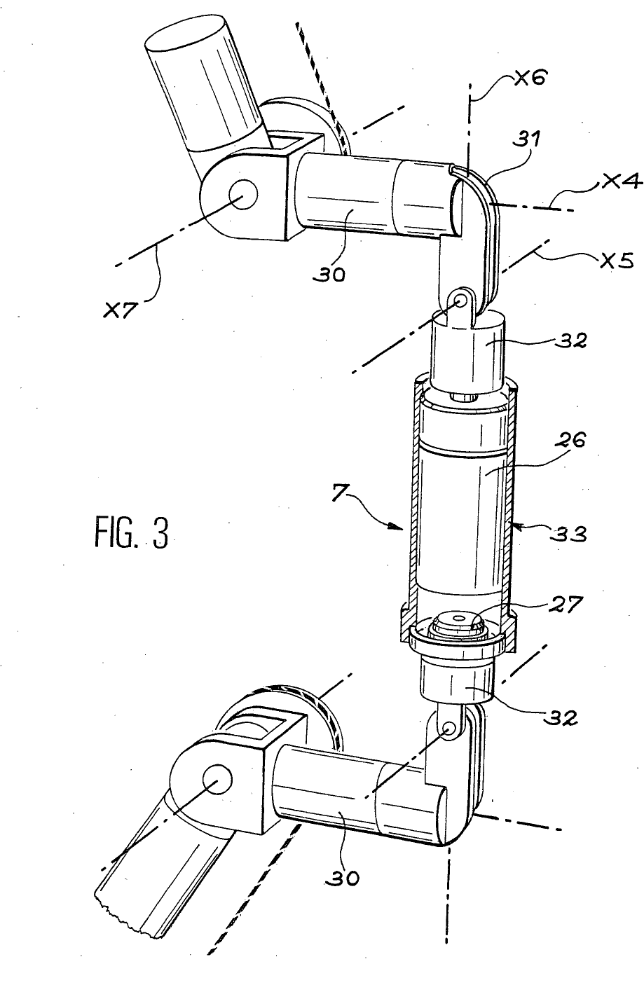

### DESCRIPTION OF EXAMPLE EMBODIMENTS

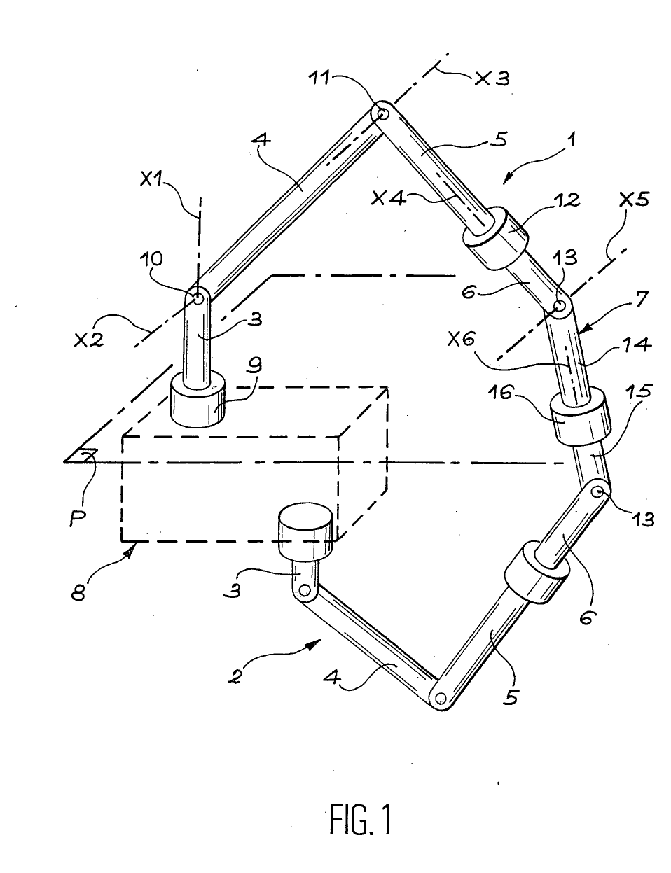

With reference to FIG. 1, it can be seen that the arm is composed of an upper branch 1 and a lower branch 2, each of which is composed of a first vertical segment 3 (the said segments 3 extending in opposite directions from a common base 8), a second segment 4, a third segment 5, a fourth segment 6, and a wrist 7 connecting the ends of the two fourth segments 6 together. The articulations successively connect the segments to each other and to the wrist, and to the common base 8 as follows: a rotary articulation with axis X1 in line with the first segment 3 and marked with reference 9 connects the first segment 3 to the common base 8; a swiveling articulation with axis X2 perpendicular to the previous axis connects the first segment 3 and the second segment 4; another swiveling articulation 11 with axis X3 parallel to the previous axis connects the second segment 4 to the third segment 5; a rotary articulation 12 with axis X4 co-linear with the third segment 5 and the fourth segment 6 connects them together and the axis X4 is perpendicular to the two previous axes; finally, a rotary articulation 13 with axis X5 perpendicular to the previous axis connects the fourth segment 6 to the wrist 7. The wrist 7 is itself composed of two co-linear parts 14 and 15 that are connected together by a rotary articulation 16 with axis X6 that is co-linear with them and perpendicular to the previous axis X5 and that can rotate with respect to parts 14 and 15. The two branches 1 and 2 are as symmetric as possible, in other words it is recommended that they should have the same number of segments arranged in the same manner and with equal lengths. However, the first segments 3 of branches 1 and 2 may have different lengths, with no major disadvantage. The common base is usually small so that the articulations 9 are close together as there is normally no advantage in offsetting them.

However, as the first segments 3 are kept in opposite directions, that is at an angle being at least 90 degrees in the meaning of this invention and which is advantageously as great as possible up to 180 degrees, the branches 1 and 2 at the outset diverge from each other from the articulations 9.

They converge toward each other only at distal ranges. The articulations 9 by which the first segments 3 are connected to the base 8 being rotary articulations in some example embodiments, the angle between the first segments 3 remains constant and a strong divergence is upheld whatever be the movements imparted to the first segments.

In the part of the description above, as in other parts of this description, position indications such as “vertical,” “upper,” etc., are not limitative since the arm can be placed in any orientation whatsoever. The “rotary” articulations make the segment that follows them rotate about its extension axis so that their direction remains the same, whereas “swiveling” articulations make it rotate about another axis so as to modify the angle between segments connected by them.

A movement applied by the operator holding the wrist 7 moves the two branches 1 and 2, essentially by using articulations 9, 10 and 11 to control translation movements of the wrist 7, and the other articulations 12, 13 and 16 to control its rotation movements. The good decoupling observed between these two groups of articulations is sufficient to facilitate control and to reduce singularities, which are often the result of too many couplings between the articulations of the arm. Another advantage specific to the invention is the reduction in the number of collisions, which is due to the distribution of branches 1 and 2 in different portions of space; one of the first three segments 3 is fixed to the top of the common base 8 and the other is fixed to its bottom, in other words they extend along opposite directions, such that the second segments 4, the third segments 5, etc., are at a wider space apart from each other owing to the strong divergence of the first segments. The branches 1 and 2 are entirely arranged in opposite halves of space separated by a median plane P, provided that it passes through the wrist 7. When the wrist is raised or lowered, the branches are moved towards each other, but the distance between them is sufficient to prevent any collisions except in extreme positions or for extreme orientations.

The first segments 3 may be offset laterally, as is shown here; but it is more advantageous for them to be in line with each other, and that the distance between the articulations 10 should be identical to the distance between the articulations 13; finally, it is advantageous that the lengths of segments 4 should be equal, and also that the lengths of segments 5 and 6 combined should be equal. The invention is better implemented, in general, when the branches 1 and 2 are completely similar, symmetrically arranged, with collinear first segments opposed at 180 degrees. The branches should comprise a same number of segments connected by corresponding articulations of the same kind in both branches (in the embodiments, both articulations 9 are rotary, both articulations 10 are swivelling, etc.). The 5 or 6 degrees of freedom are afforded by two branches each comprising three mobile segments.

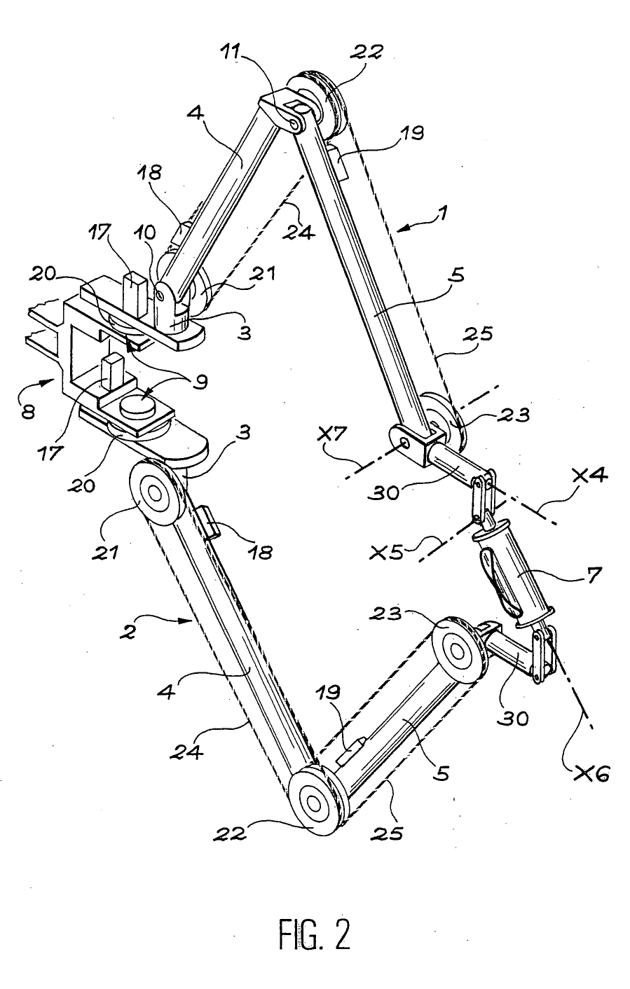

FIG. 2 shows an improved embodiment. Branches 1 and 2 comprise a first short segment 3 followed by a second segment 4 which is fairly long and a third segment 5 which is equally long. The articulations 9, 10 and 11 are identical to the previous embodiment.

The equal lengths of the second and third segments 4 and 5 attached to the much shorter length of the other elements of the arm make its shape almost a perfect diamond, which is excellent to give a wide range of displacements free of collisions.

The arm in FIG. 2 is innovative in that it comprises a wrist holder 30 between the third segment 5 and the corresponding end of the wrist 7. The distal end of the third segment 5 is articulated to the wrist holder 30 through an articulation axis X7, which will advantageously be made parallel to axes X2 and X3. The wrist holders 30 comprise ends 31 that rotate about an axis X4, coincident with a general direction of elongation of the wrist holders 30; end pieces 32 are fixed to the ends 31 with the ability to rotate about them about the X5 axes perpendicular to X4 axes, and a handle 33 connects the end pieces 32 to each other, keeping them co-linear with each other, while being free to rotate about an axis X6 coaxial with them. Advantageously, this axis is orthogonal to the pairs of axes X4 and X5 described above in a reference configuration. The handle 33 pivots about axis X6 without changing the distance between the X4 axes or the wrist holders 30, which avoids the risk of creating any collisions by bringing the branches close to each other.

The X4, X5 and X6 axes are degrees of freedom identical to the previous degrees of freedom, in that they are formed by rotary articulations for X4 and X6, and swiveling articulations for X5. The axis X7 is formed by a swiveling articulation but it is not a real degree of freedom as will be explained.

An essential element to be considered is that the wrist holders 30 and their axes X4 form a constant angle with fixed planes, in this case horizontal planes, which limits the risk of introducing singularities. This is created using a transmission comprising a support pulley 21 coaxial with axis X2 and fixed to the first segment 3, a return pulley 22 coaxial with the axis X3 and that can turn freely on segments 4 and 5, a support pulley 23 coaxial with axis X7 and fixed to the wrist holder 30 and two belts 24 and 25 tensioned respectively between pulleys 21 and 22, and 22 and 23, thus forming a chain, for each branch 1 and 2. Regardless of the movement applied to segments 4 and 5, the action of the belts 24 and 25 holds the axis X7 in a direction identical to the vertical plane that they form, since the pulley 21 remains fixed.

The wrist holders 30 kept at a constant orientation increase decoupling between rotation movements and translation movements for the wrist assembly 7.

We will now describe the arm actuation mode. Motors are used to feedback forces felt at the slave arm or generated by a computer simulation, to the operator. These motors 17 are arranged on the fixed base 8 and assist in rotating the first segments about the axis X1 using a gear, a belt or another transmission, motors 18 are placed on the X2 axes and are used to rotate the second segments 4 with respect to the first segments 3, other motors 19 are placed on the X3 axes and are used to adjust the angles between the second and the third segments 4 and 5. The motors can also be placed on the X2 axes; their movement is then transmitted to the X3 axes using a pulley or other type of transmission, and particularly a connecting rod transmission, corresponding to a parallelogram type assembly well known to those skilled in the art. There is no need to place the motor on the X7 axes which are controlled otherwise, nor on X4 and X5 axes since the rotations about these two axes are a result solely of movements at the ends of the third segments 5; but a motor 26 for force feedback to the handle 33 may be added so as to control the degree of freedom for rotation about the X6 axis. Advantageously, the motor 26 can be fixed to a duct forming the handle 33 installed on one of the end pieces 32 free to rotate by means of a bearing 27, while the output shaft from motor 26 is connected to the opposite end piece 32. It may also be installed elsewhere, on the base 8 or on one of the branches 1 or 2, which however necessitates a transmission device to the handle 33.

Sensors such as angular position encoders are associated with the different motors to measure their movements and to indicate the state of the arm and the imposed controls, but these techniques are also known in this case and will not be described in this text. If a degree of freedom is superfluous, the rotary control of the handle 33 which is the most difficult to produce precisely and comfortably, may be eliminated.

The device at the end of the arm is not necessarily a handle, but it may also be a pen, a ball, a clamp, etc., depending on the envisaged applications, for example games, simulation devices, remote handling, remote operation or remote displacement for various industries.

The present invention includes the aspect of a control arm that has a great number of functions for expressing various commands. The functions can be materialized by respective degrees of freedom of the arm. As it is well known, the degrees of freedom are elemental displacements allowed to a solid body and into which its movement may be decomposed. A totally free body enjoys 6 degrees of freedom, 3 in translation (typically, they are considered along orthogonal axes Y, Y and Z) and 3 in rotation (typically about the same axes X, Y and Z). In articulated control arms, the movements along the degrees of freedom are felt and imparted by the operator holding the wrist at the free and, but they are actually measured at the articulations, often fitted with sensors measuring the angular displacements.

When a great number of degrees of freedom must be obtained, the designer must cope with difficulties arising from kinematical “singularities” of the arm. Singularities are present when a position (or orientation) of the controlled free end either cannot be reached owing to interferences of segments along the arm, or cannot be related to a determined position of the articulations so that the measurements cannot be exploited.

The present invention provides the aspect of an arm that has two parallel branches, each comprising three degrees of freedom (or three articulated segments) and joining at free ends to a wrist that provide five degrees of freedom (or six if the wrist has a supplemental articulation. This is beneficial over the prior art. In particular, the prior art comprises arrangements with a plurality of branches connected to a planar base by segments that raise in substantially same directions. The branches constantly converge towards each other from the base to the wrist. The connection points to the base must be widely spaced apart to avoid interferences and provide a sufficient working volume to the wrist. However, the arm becomes bulky.

1. Robot arm consisting of two branches (1, 2), each of said branches including symmetrically articulated segments (3, 4, 5, 6), one end of each of the branches being connected by a wrist (7), said wrist being free to move in at least three translations and in at least two rotations, and another end of each of the branches being connected to a fixed common base (8) through an articulation (9), characterized in that the branches are made so as to move in two halves of space on opposite sides of a separation plane (P) when the wrist (7) is intersected by said plane, and in that first segments (3) of the branches which are connected to the base (8) extend from said base and away from each other along directions that form an angle of between 90 degrees and 180 degrees.

2. Robot arm according to claim 1, characterized in that the first segments (3) of the branches (1, 2) that are connected to the base (8) are connected through pivoting articulations (9) such that the first segments (3) are held at invariable directions relative to the base (8).

3. Robot arm according to claim 2, characterized in that the segments connected to the base are co-linear.

4. Robot arm according to claim 1, characterized in that the branches comprise at least three segments (3, 4, 5).

5. Robot arm according to claim 1, characterized in that it comprises wrist holders (30) connecting the branches to the wrist and held at a constant orientation by transmissions (21 to 25).

6. Robot arm according to claim 1, characterized in that the wrist (7) comprises a pivoting handle (33) with a force feedback motor (26).

7. Robot arm according to claim 2, characterized in that the branch segments are connected to each other and to the base by articulations with a force feedback motor.

8. Robot arm consisting of two branches (1, 2), each of said branches including symmetrically articulated segments (3, 4, 5, 6) one end of each of the branches being connected by a wrist (7), said wrist being free to move in at least three translations and in at least two rotations, and another end of each of the branches being connected to a fixed common base (8) through an articulation (9), wherein the branches are made so as to extend, starting from the said common base, in two halves of space on opposite sides of a separation plane (P), when the wrist (7) is intersected by said plane, and in that first segments (3) of the branches are connected to the base through rotating articulations (9) that extend from said base and away from each other along directions that form an angle of between 90 degrees and 180 degrees.
